(19) United States
(12) Patent Application Publication
(10) Pub. No.: US 2017/0238514 A1
(43) Pub. Date: Aug. 24, 2017

(54) Fishing Lure

(71) Applicant: Richard E. Hrncir, Palmer, TX (US)

(72) Inventor: Richard E. Hrncir, Palmer, TX (US)

(21) Appl. No.: 15/049,027

(22) Filed: Feb. 20, 2016

(51) Int. Cl. A01K 85/01

(52) U.S. Cl. CPC A01K 85/01

(57) ABSTRACT

A fishing lure includes a lure body having a head portion and a tail portion. The head portion has a bill arranged to cause transverse motion of the head portion with respect to a direction of the lure body through water. The lure body includes a pocket formed in a lower surface thereof, surfaces of the pocket lined with a rigid material. At least one rattle is disposed in the pocket and arranged to generate a rattling sound when the lure body is moved through water.

### CROSS REFERENCE TO RELATED APPLICATIONS

Not Applicable

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates generally to the field of fishing lures. More particularly, this disclosure relates to a fishing lure that includes a lure body comprising a head portion and a tail portion.

Slabs and jigs are well known types of fishing lures and are used to attract a variety of fish species. Slabs typically include one or more hooks attached to a slab body, which may be formed from a number of materials, including lead. Jigs typically have hooks partially embedded within a jig body, which may be formed from lead or another relatively dense material. Slabs known in the art generally have one or more hooks attached to the slab body, wherein the slab body is designed to mimic the size, coloring, and shape of a bait fish. Jigs known in the art generally include spinners or propellers to add desirable fish-attracting effects. The spinners or propellers are generally attached to a shank that is fixed relative to the slab body.

A representative example fishing lure known in the art is described in U.S. Pat. No. 7,743,549 issued to Troutman. Relevant features of the lure described in the foregoing patent include a hook having a bend adjacent a barb to define a rear end of the lure and a shank extending toward an opposite front end of the lure. A lure body is attached to a portion of the shank of the hook and a movable support member extends from the lure body toward the front end of the lure and generally away from the rear end of the lure. A movable member, such as a spinner blade or a propeller, is movably associated with the movable support member for moving during use of the lure to attract fish to the lure. The movable member is located forward of the lure body adjacent the front end of the lure. A line attachment member is located adjacent the body for securement of a fishing line to the lure. The line attachment member is located between the rear end of the lure and the movable member. In a preferred embodiment, the line attachment member is provided by an eye of the hook that extends from the lure body.

Another type of lure known in the art is a hard bait lure, which may also be referred to as a crank bait or a twitch bait. These lures are typically formed from rigid materials that are buoyant in water. The lures may include attachments for a fishing line and for one or more hooks, such as treble hooks. These hard bait lures may further be painted to mimic fishing bait. For example, one such prior art hard bait lure has a unitary body. The body includes an attachment for a fishing line at the rear of the body. One or more treble hooks may be positioned at the front and rear of the lure body. The lure body may be painted to resemble a typical bait, such as a grasshopper or a cricket. When pulled through the water by the attached fishing line, the unitary bait is designed to mimic the natural behavior of the bait.

### SUMMARY

A fishing lure according to one aspect includes a lure body and a rattle. The rattle is movable within the lure body such that the rattle may move relative to the lure body when the lure is pulled through the water.

A fishing lure according to one aspect includes a lure body and a pendulum-type rattle. The pendulum-type rattle is movably coupled to the lure body such that the rattle may move relative to the lure body when the lure is pulled through the water.

In one embodiment the lure includes a lure body and a pendulum-type rattle. The movement of the lure through the water mimics the behavior of certain types of bait species. In one embodiment the lure is attached to and pulled by a fishing line and the lure moves through the water in a manner that appears to be a crayfish darting or scuttling rearwards. This movement pattern accurately reproduces the movement of a crayfish in nature. As the lure moves through the water, the pendulum-type rattle moves relative to the lure body and produces a rattling sound that is attractive to fish. Another embodiment includes a lure body having a lure body and a pendulum-type rattle. As the lure moves through the water, the pendulum-type rattle moves relative to the lure body and impacts a rigid material positioned proximate the rattle. The contact between the pendulum-type rattle and the rigid material produces a rattling sound that is attractive to fish. Further, the movement of the lure through the water accurately reproduces the movement of a crayfish in nature.

The lure body may be made of a variety of materials known in the art, including rigid or semi-rigid materials such as balsa wood and plastic. The lure body may also include hooks and other features, including an attachment for a fishing line, a swivel, or other means for coupling a fishing line to the fishing lure. The lure comprises one or more rattles disposed in the lure. One embodiment includes a pendulum-type rattle disposed proximate the centerline that oscillates as the lure moves through the water.

Other aspects and advantages will be apparent from the following description and the appended claims.

### BRIEF DESCRIPTION OF THE DRAWINGS

FIG. 1 shows an example embodiment of a lure according to the present disclosure.

FIG. 2 shows a side view of an example embodiment of a lure according to the present disclosure.

FIG. 3 shows a perspective view of an example embodiment of a lure according to the present disclosure.

FIG. 4 shows a cross section of an example embodiment of a lure according to the present disclosure.

FIG. 5 shows a cross section of an example embodiment of lure according to the present disclosure.

FIG. 6 shows an example of a pendulum-type rattle according to the present disclosure.

FIG. 7 shows an example of a bead and rattle assembly according to the present disclosure.

FIG. 8 shows an example tail according to the present disclosure.

FIG. 9 shows an example tail according to the present disclosure.

FIG. 10A shows an example bill according to the present disclosure.

FIG. 10B shows an example front view (looking rearward) of a bill according to the present disclosure.

FIG. 10C shows an example lure according to the present disclosure.

### DETAILED DESCRIPTION

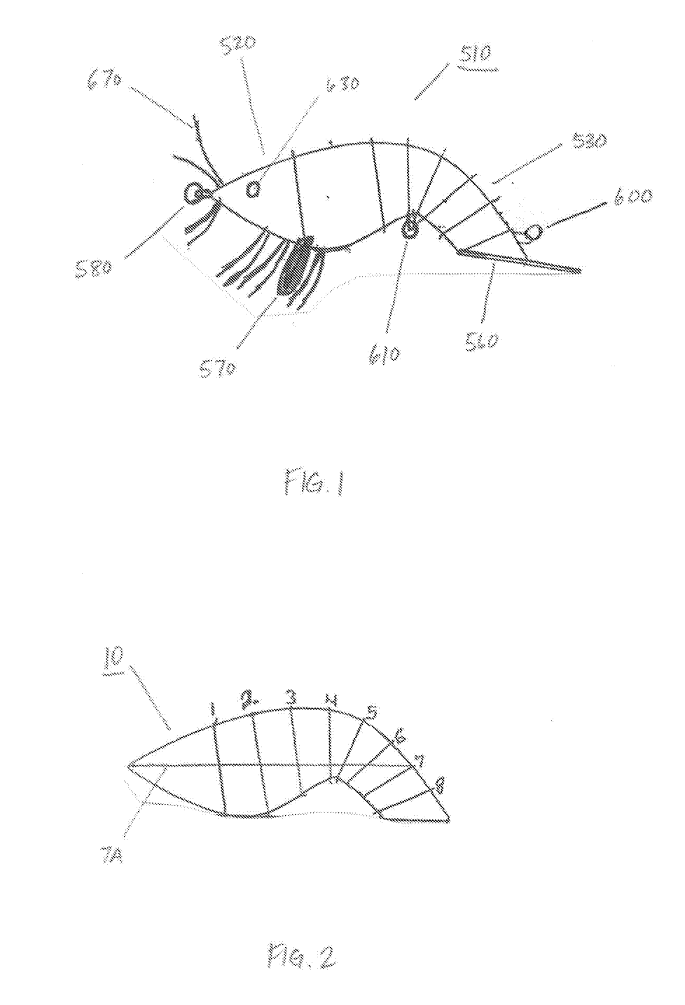

In an example embodiment, shown in FIG. 1, a fishing lure (lure) 510 may be a solid bodied lure. The lure 510 includes a lure body having a head portion 520 and a tail portion 530. The lure body, including the head portion 520 and the tail portion 530, may be formed from any suitable material known in the art. In one embodiment, the lure 510 may be formed from balsa wood. In another embodiment, the lure 510 may be formed from any plastic or other semi-rigid material having a suitable density for use in fishing lures. In another embodiment, the lure 510 may be formed from any material known in the art that has a density approximately that of balsa wood or which is suitable for use in fishing lures, including for use in crank and twitch baits.

The head portion 520 includes a hook attachment 580 that may also include a split ring, a swivel, or other attachment features known in the art. A hook (not shown), such as a treble hook, may be coupled to the hook attachment 580. The head portion 520 may also include ornamentation such as an eye 630, antennae, whiskers, or feelers 670, and other devices intended to simulate a bait species. The example implementation shown in FIG. 1 is intended to mimic a crayfish.

The head portion 520 may also include a device such as a bill 570. The bill 570 may help ensure that the movement of the head portion 520 through water is consistent. The bill 570 may also help ensure that movement of the head portion 520 is in a lateral plane that is roughly horizontal to the tail portion 530. This distinctive movement, called “wobble”, is characteristic of a crayfish as it moves in water and is one of the possible advantages of a lure according to the present disclosure. The bill 570 may be made from metal, plastic, or any other suitable material and may be shaped to produce a desired movement of the lure 510 in water.

In one embodiment, the head portion 520 may further include one or more hollow cavities, positioned, for example, into the material of the head portion 520 from its lower surface. The one or more cavities may be filled with weights of different sizes (often referred to as “shot” or “split shot”). In some embodiments, the total weight may be adjusted so that the lure 510 is substantially neutrally buoyant in water. In other embodiments, different weights may be selected for use with the lure 510 such that the lure 510 assumes other orientations when submerged. Alternatively, the one or more hollow cavities may include both weights and one or more “rattlers” (not shown), or the weights themselves may serve as rattlers designed to create a distinctive rattling sound when the lure 510 moves through water. In some embodiments, the rattlers (not shown) may be formed using two or more brass beads (not shown) positioned in the one or more hollow cavities and permitted to contact one another when the lure 510 is pulled through water. In other embodiments, the walls of the one or more hollow cavities may be lined with metal or another material that enhances the rattling sound produced by the rattlers.

In another embodiment the one or more hollow cavities may be filled with a sufficient quantity of “rattlers” such that few if any weights are required to achieve neutral buoyancy. Once the weights or rattlers (not shown) are placed in the one or more cavities, the cavities may be sealed with glue, epoxy, or any other suitable material known in the art, or the cavities may be covered with a seal of a type known in the art in order to seal the cavities and make the cavities water-tight.

The tail portion 530 of the lure 510 may be shaped to resemble the body of a bait species, such as a crayfish. The tail portion 530 may include an attachment 600 to which a fishing line (not shown) may be connected. In some embodiments, a fishing line may be connected to the attachment 600 using a split ring, a swivel, or any other attachment mechanism or device known in the art. In other embodiments a fishing line may be directly connected to the attachment 600.

In one embodiment, the attachment 600 may be positioned along the tail portion 530 in such a way that the lure 510 will remain in approximately the orientation shown in FIG. 3 when the lure 510 is pulled through water. Specifically, the head portion 520 may include weights in the one or more hollow cavities (not shown) such that the head portion 520 remains roughly in the position shown in FIG. 3 when the lure is submerged. When the lure 510 is positioned as shown in FIG. 3 and is pulled through the water, the head portion 520 is designed to move back and forth (i.e., in and out of the plane of the page) such that the movement of the lure 510 mimics the behavior of a crayfish when it darts or scuttles along the bottom of a body of water. Such naturally appearing movement of the lure 510 may be attractive to many fish species.

Referring again to FIG. 1, the tail portion 530 may also include a tail 560. The tail 560 may serve one or more functions, depending on the particular features of any embodiment. In one example embodiment, the tail 560 may serve as a brake that slows the descent of the lure 510 when it is placed in water. In another example embodiment, the tail 560 may serve as a “plane” or “diving plane” that helps keep the lure 510 close to the bottom of the body of water in which the lure 510 is submerged. In another example embodiment, the tail 560 may be designed to control the manner in which the lure 510 is oriented as it is pulled through the water. For example, if a fishing line is attached to attachment 600 and the lure 510 is pulled in a rearward direction, the tail 560 will act to pull the tail portion 530 downward thereby maintaining the shape of the lure 510 in a substantially natural orientation, as shown in FIG. 1. Further, some embodiments of a lure according to the present disclosure may use the tail 560 for more than one of the foregoing design considerations. In some embodiments, the tail portion 530 may also include a weight (not shown) made from a high density material such as lead disposed near the base of the tail 560. A weight may help maintain a selected orientation of the tail portion 530 with respect to the head portion 520 when the lure 510 is submerged. In one embodiment, the weight may be about 0.2 ounces.

In one embodiment, the tail 560 may be sized to enable the lure 510 to sink in water at a controlled rate. For example, in one embodiment the tail 560 may be sized and/or shaped such that the lure 510 will descend at a rate of approximately 0.1 to 1.0 feet per second. However, the scope of the present disclosure is not limited to these example rates of descent, and other rates may be selected by appropriately sizing and shaping the tail 560 and selecting other properties of the lure 510, such as the overall weight of the lure 510 and the density of the material used to make the various portions of the lure 510. In other embodiments, the tail 560 may be sized and positioned such that it helps prevent the lure 510 from being caught on submerged debris.

Furthermore, the location of the attachment 600 may be selected to enable other orientations of the lure 510 when the lure 510 is submerged and is pulled through water. In one embodiment, a distance between the bottom-most edge of the attachment 600 and the tail 560 may be approximately 0.875 (⅞) inches.

The lure 510 also include one or more additional attachments, such as additional attachment 610. The additional attachment 610 may be configured to connect to a second hook (not shown), such as a treble hook. In some embodiments, the additional attachment 610 may further include a split ring or other device that connects the additional attachment 610 to the second hook (not shown). In other embodiments, the second hook (not shown) may be a short shank treble hook selected such that the second hook (not shown) will not interfere with the movement of the lure 510 and, specifically, such that the second hook (not shown) will not interfere with the movement, orientation, or attitude of the tail 560.

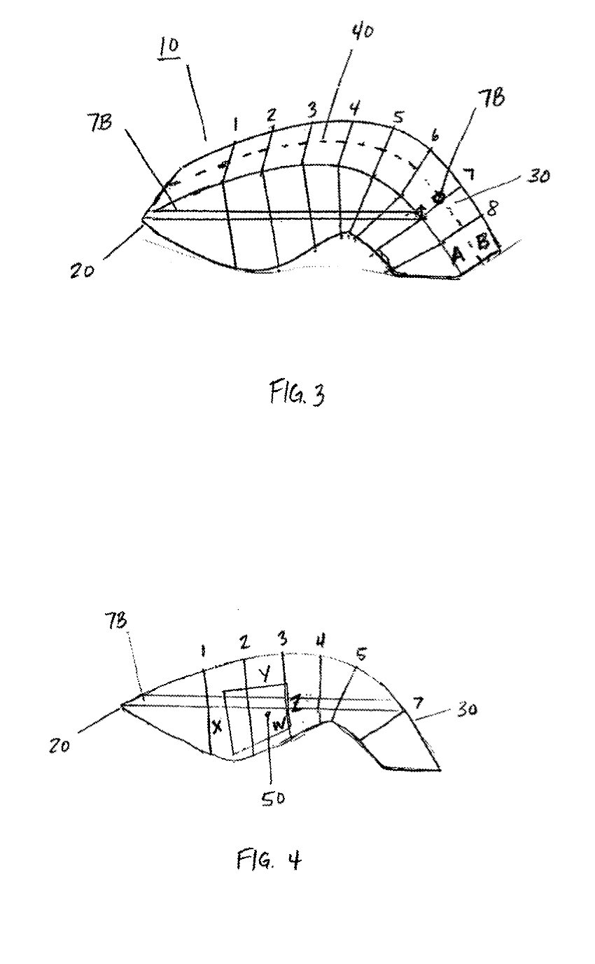

In one embodiment of a lure according to the present disclosure as shown in FIG. 2, the lure body 10 may be formed from a solid material, such as balsa wood or any other material suitable for a fishing lure. The lure body 10 may be formed in one piece or a plurality of separate pieces. If formed in multiple pieces, the lure body 10 may be assembled using a suitable adhesive or mechanical attachment to connect the pieces. In the embodiment shown in FIG. 2, the lure body 10 is formed from a single piece of material, such as plastic or balsa wood of a suitable density, which may then partitioned in order to include other features of a lure according to the present disclosure.

Lines (1-8) shown in FIG. 2 are reference lines that may be useful in understanding the positioning of elements on and within the lure body 10 of an example embodiment of a lure according to the present disclosure. Accordingly, the lines (1-8) are not part of the lure, notwithstanding the fact that lines or markings may be included on the exterior of the completed lure body 10 in order to improve the appearance of the lure in resembling, for example, a crayfish. As shown in FIG. 2, lines 1 and 3-8 were measured from the shell (or carapace) of an actual crawfish and included in the Figure. In some embodiments, these carapace lines may be added to the lure when assembly is complete and lure is being painted to resemble a live crawfish. Line 2 and horizontal line 7A are reference line. Lines (1-8) will be referenced in the description of the example embodiment shown in FIG. 2. One embodiment of the lure is roughly 13/16 inches wide, 3⅛ inches long, and 1 inch tall.

In one embodiment, shown in a perspective view in FIG. 3, a hole 7B may be drilled along a line parallel to line 7A from a nose 20 of the body 10 to a tail 30, that is, longitudinally along the lure body 10. In one embodiment, the hole 7B may have a diameter of ⅛ inches. In one embodiment, the hole 7B may be formed roughly ⅛ inch above and parallel to line 7A. In some embodiments, hole 7B forms a reference line that may be used to form and assemble the lure. Once the hole 7B has been formed, the body 10 may be cut along a line shown at 40 and divided into segments A and B. In one embodiment, the thicknesses of the segments A and B are roughly equal. In other embodiments, the thicknesses of the segments A and B may be different. For example, in one embodiment the hole 7B may lie entirely within segment B. In one embodiment, the hole 7B may lie entirely within segment A. In one embodiment, the hole 7B may lie roughly equally within segments A and B.

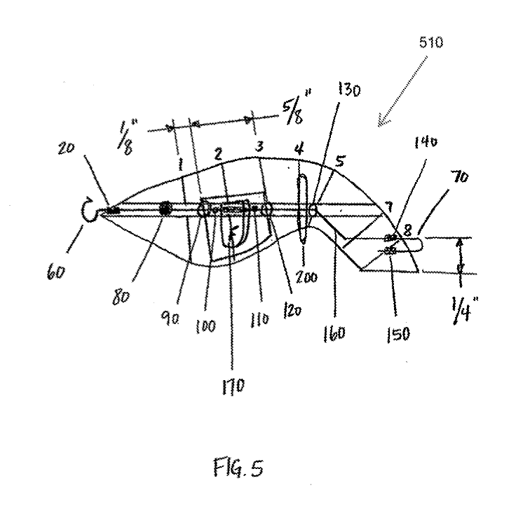

FIG. 4 shows a cross sectional view of one example embodiment of a lure. FIG. 4 is a cross sectional view of the interior of a lure body 10 cut along line 40 in FIG. 3. The hole 7B is visible in the cross sectional view. Also visible in this embodiment is a rattle pocket 50. The rattle pocket 50 has sides W, X, Y, and Z. The rattle pocket 50 also has a selected depth (not shown). In one embodiment the depth of the rattle pocket 50 is about 7/32 inches. In another embodiment, the depth of the rattle pocket 50 may be about ¼ inch. In another embodiment, the depth of the rattle pocket 50 is selected so that there is approximately ⅜ inches of clearance for a rattle to move in the rattle pocket 50 once the rattle pocket 50 has been lined with a material that will create a rattling noise when contacted by a rattler. The rattle pocket 50 may be sized as needed to hold a sufficient number of rattlers to either generate a desired amount of rattling sound when the lure is moved through water and/or to obtain a desired buoyancy of the lure in the water.

In one embodiment, the rattle pocket 50 is sized to accommodate a pendulum-type rattle. For example, side X may be 9/16 inches long, side Y may be ⅝ inches long, and side Z may be 7/16 inches long. Side W is of sufficient length to connect sides X and Z. In one embodiment, side W is about ⅝ inches long. In one embodiment, the rattle pocket 50 is positioned so that side W is positioned roughly 1/16 inches inside the lower edge of the lure body 10. In one embodiment, side Z is positioned approximately on reference line 3. In such an embodiment, line X is positioned ⅝ inches toward the nose 20 of the lure body 10 (e.g., ⅝ inches forward from reference line 3).

In one embodiment, the rattle pocket 50 may be lined with a material that will create a rattling noise when contacted by a rattler. In one embodiment, the rattle pocket 50 may be lined with a plastic or polymeric material. In another embodiment the rattle pocket 50 may be lined with a rigid plastic material such as LEXAN brand plastic or similar material. LEXAN is a registered trademark of Sabik Global Technologies, B.V., 1 Bergen op Zoom 4612 PX, The Netherlands. In another embodiment, the rattle pocket 50 may be lined with a metal such as aluminum. The liner material (not shown) may be sized to fit within the rattle pocket 50. In one embodiment the liner material (not shown) may be glued in place with a suitable adhesive. In another embodiment the liner material (not shown) may be press fit into the rattle pocket 50. Any other suitable means of attaching the liner material (not shown) to the rattle pocket 50 may be used. The rattle pocket 50 may also be made water tight by using an appropriate material before or after the liner material (not shown) has been inserted into the rattle pocket 50. The surface of the hole 7B may also be coated with a suitable waterproofing material. In another embodiment, the entire exposed internal surface of the lure may be coated with a suitable waterproofing material.

After the rattle pocket 50 has been formed, in one embodiment a wire shaft 60 may be prepared for placement in the hole 7B. In the embodiment shown in FIG. 5, one or more additional elements may be coupled to the wire shaft 60 either before or after the wire shaft 60 is placed in the hole 7B. In one embodiment, the wire shaft 60 is formed from stainless steel wire. In one embodiment, the wire shaft 60 is approximately 0.40 inches in diameter. Other diameters may be selected for the wire shaft 60 as may be appropriate for the size and configuration of the lure body 10. The wire shaft 60 may be a continuous length that runs from the nose 20 of the lure body 10 to the tail 30 of the lure body 10. As shown in FIG. 5, the wire shaft 60 may exit and reenter the lure body 10 near the tail 30 of the lure body 10. An exposed portion 70 of the wire shaft 60 may form all or part of the attachment 600 to which a fishing line (not shown) may be attached to the lure. The wire shaft 60 near the nose 20 of the lure may form all or part of the hook attachment 580 (see FIG. 1). In the embodiment shown in FIG. 5, the bend 160 in the wire shaft 60 extends approximately 5/16 inches below the hole 7B before the wire shaft 60 again runs parallel to hole 7B and forms the exposed portion 70 of the shaft. In one embodiment, the top of the exposed portion 70 of the wire shaft is approximately ¼ inch from the bottom of the lure as shown in FIG. 5.

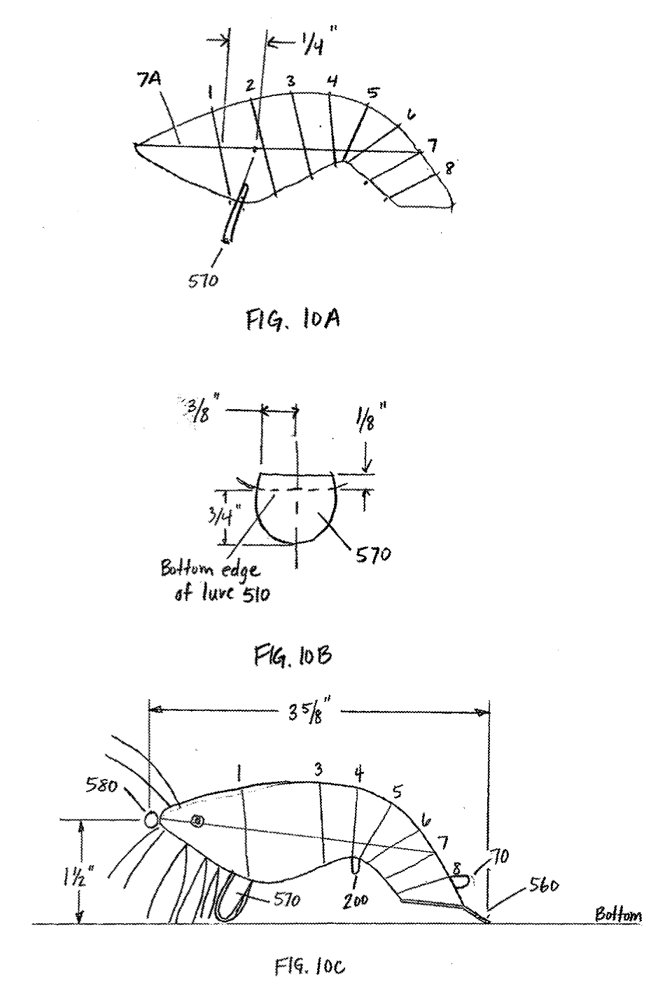

As shown in FIG. 5, one embodiment of the lure may include weights such as beads 80, 90, 100, 110, 120, 130, 140, and 150 positioned as shown. Other embodiments may include a larger or smaller number of beads, sleeves, or tubes as desired, and the positioning of these elements may vary. The weights or beads may be solid or hollow and may be formed from lead, steel, brass, or any other suitable substantially rigid material. In the embodiment shown in FIG. 5, bead 80 is a 1/16 inch diameter drilled #7 split shot, bead 90 is a 7/32 inch diameter hollow bead, beads 100 and 110 are 5/32 inch diameter solid beads, bead 120 is a 7/32 inch diameter hollow bead, bead 130 is a 7/32 inch diameter hollow bead, and sleeves 140 and 150 are #3 brass tubes. The lure also includes a clip 200 that is positioned with the lure body to secure the wire shaft 60 in place and to form at least a portion of the attachment 610 (shown in FIG. 1). The weight of each bead, sleeve or tube, the specific gravity of the material forming the lure body 10 and the longitudinal position of each bead, sleeve or tube along the hole 7B may be selected such that the lure 510 maintains a selected orientation in the water with reference to the length of the lure 510. An example of such orientation will be further explained with reference to FIG. 10C.

The embodiment shown in FIG. 5 also includes a rattle 170 that is positioned between beads 100 and 110. In this embodiment, the rattle 170 acts as a pendulum and is capable of rotating relative to the wire shaft 60. The rattle 170 may be formed from any suitable material. In this embodiment, the rattle 170 is formed from lead, is rotatably coupled to the wire shaft 60, and swings back and forth about the wire shaft 60 as the lure is pulled through the water. In one embodiment, the rattle 170 weighs approximately 5 grams. The rattle 170 is positioned within the rattle pocket 50 and, when rotating about the wire shaft 60, will contact the interior of the rattle pocket 50 (e.g., the rattle 170 will contact the liner material (not shown)) and generate a rattling noise that is highly attractive to fish. The pendulum-type movement of the rattle 170 in the present embodiment is generated by the side-to-side scuttling movement of the lure through water. The movement of the lure through water, and the movement of the pendulum-type rattle 170, may be obtained in the present embodiment by adjusting the size and position of the bill 570, and/or tail 560. In other embodiments, the movement of the lure through water, and the movement of the pendulum-type rattle 170, may be obtained by adjusting the shape of the lure body or other aspects of the lure. The movement of the pendulum-type rattle 170 about the wire shaft 60 is advantageous in that the pendulum-type rattle 170 may substantially freely move with reference to the wire shaft 60 and the lure body 10 so that the lure 510 will maintain a desired orientation as it is pulled through the water. In one embodiment, the pendulum-type rattle 170 will move back and forth with reference to a gravitationally neutral position relative to the lure body 10 such that the lure body 10 will remain in a substantially horizontal plane when moving side-to-side in the scuttling movement pattern described above and resulting from action of the bill (570 in FIG. 1).

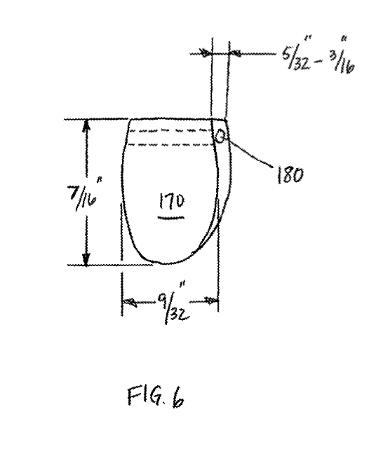

FIG. 6 shows a side view of a rattle 170. The rattle 170 comprises a 3/32 inch diameter hole 180 through which the wire shaft 60 passes when the rattle is assembled in the lure. In the embodiment shown in FIG. 6, the hole 180 also includes a #3 brass sleeve inserted into the hole 180. The brass sleeve may be press fit or glued into the hole 180. Note that while the sleeve in this embodiment is formed from brass, other materials are suitable and may be used with the lure. Moreover, the size of the hole 180 may be adjusted to accommodate wire shafts 60 of different diameters. The rattle 170 shown in FIG. 6 is approximately 9/32 inches wide and approximately 5/32 or 3/16 inches thick. It will be understood by a person skilled in the art that the size, shape, and material of the rattle 170 may be adjusted to produce the desired rattling noise in connection with the lure.

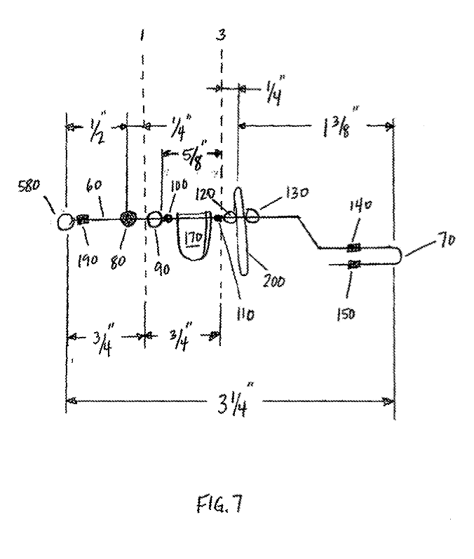

FIG. 7 shows a detailed view of the bead arrangement in one embodiment of the lure. As shown in FIG. 7, the wire shaft 60 may also include a brass sleeve 190 positioned near the nose 20 of the lure. The dimensions shown are in accordance with the embodiment shown in FIG. 7, and other dimensions may be used for other embodiments.

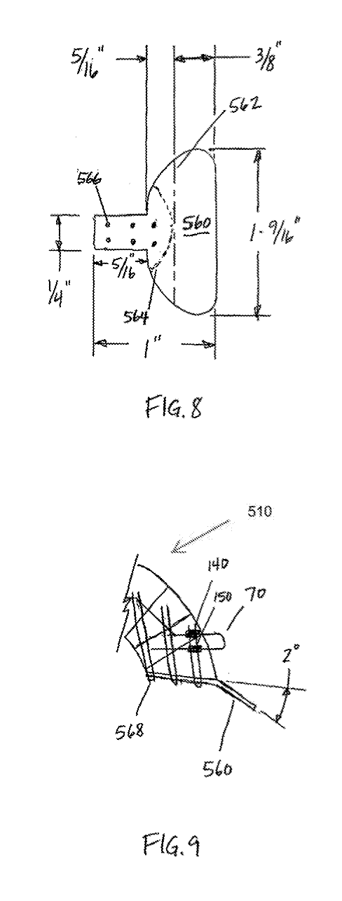

Once the interior components of the lure have been assembled, segments A and B of the lure may then be reassembled and reconnected using adhesive or mechanical attachments. In one embodiment, the segments A and B are reattached using waterproof adhesive. After the segments A and B have been reattached, the lure body may be shaped to resemble, for example, a crawfish. After shaping is completed, the tail 560 may be formed. In one embodiment, the tail 560 is formed 22 gauge steel that may be obtained from many fishing lure or hardware suppliers. The tail 560 is then shaped to resemble the tail of a crawfish as shown in FIG. 8. The tail 560 may also be bent as shown in FIG. 9 in order to help control the manner in which the lure is positioned when it sinks, or dives, in the water. In one embodiment, a portion of the tail 560 is bent downward at a 2 degree as shown in FIG. 9.

Specifically, FIG. 8 shows the tail 560 of one embodiment of the lure. The tail 560 may be attached to the lure using U-shaped pins or any other suitable adhesive or mechanical attachment. In the embodiment shown in FIG. 8, both adhesive and mechanical attachment using the 0.40 diameter U-shaped pins are used to provide a strong attachment between the tail 560 and the lure body. In the embodiment shown in FIG. 8, the tail 560 may be bent along a bend line 562 in order to achieve a desired orientation of the lure in the water or to achieve a desired dive angle or rate of dive as the lure is cast into or pulled through the water. In another embodiment, the tail 560 may include a pocket 564 as shown in FIG. 8. The pocket 564 may be formed, for example, by striking the tail 560 with a hammer, although any other method of forming the pocket 564 is acceptable. In one embodiment, the pocket 564 is formed in a manner that helps stabilize the movement of the lure through the water. Holes 566 may be drilled in the tail 560 to accommodate U-shaped pins (568 in FIG. 9) that may be positioned in the lure in order to engage wire shaft 60 and other elements, including sleeves 140 and 150 (as shown in FIG. 9). The U-shaped pins 568 may be formed from, for example, 0.40″ diameter wire.

FIG. 9 shows an embodiment of the lure in which the tail 560 is positioned at an angle relative to the lure in order to achieve a desired dive angle and dive rate. The slope of the tail 560 relative to the lure body may be set as desired to obtain such angle and rate. In the embodiment shown in FIG. 9, the tail 560 is bent at an angle of approximately 2 degrees along bend line 562 (shown in FIG. 8) to produce the desired dive angle. Other bend angles may be used in other embodiments.

FIGS. 10A and 10B show the bill 570 of one embodiment of the lure. The bill 570 of the embodiment shown in FIG. 10 is formed from Plexiglas heated to take the shape of a #3 deep cup Colorado blade. The cupped portion of the bill 570 is positioned facing rearward (e.g., facing the tail 560) in order to generate the side-to-side wobbling or scuttling motion of a crawfish. The bill 570 is attached to the lure 510 with waterproof adhesive. Other embodiments may include other mechanisms to attach the bill 570 to the lure 510.

Once the lure has been assembled, it may be finally shaped into the desired configuration. For example, as shown in the Figures the lure may be formed into a crawfish. The lure may then be waterproofed and painted to closely resemble the desired bait. Whiskers, eyes, and other appendages may be added to the lure to improve its life-like appearance. Hooks may be selected in order to affect the attitude of the lure in the water. For example, the weight difference between two #4-3x treble hooks and two #4-4x hooks will change the flotation angle of the lure. The total weight of one embodiment of the lure complete with hooks and split rings is roughly 20 grams (0.7 to 0.8 ounces).

FIG. 10C shows one embodiment of the lure. In this embodiment, the weights of the lure components are selected such that the weight of the lure, including the hooks, provide sufficient buoyancy such that the hook attachment 580 of the lure is positioned approximately 1.5 inches above the bottom when the rearmost tip of the tail 560 is resting on the bottom. This position gives a natural presentation of a crawfish standing on the bottom with its tail touching the bottom. The weights in the lure may be varied so that other attitudes of the lure are achieved when the lure moves through the water and when the rearmost tip of the tail 560 is resting on the bottom. In the embodiment shown in FIG. 10C, the overall length of the lure is approximately 3.625 inches. Other embodiments may have different overall lengths. For example, embodiments depicting larger or smaller crayfish may have overall lengths that are greater than or less than the example embodiment of 3.625 inches.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A fishing lure, comprising:
a lure body having a head portion and a tail portion, the lure body comprising a bill arranged to cause transverse motion of the head portion with respect to a direction of the lure body through water, the head portion comprising a pocket formed in a lower surface thereof, surfaces of the pocket lined with a rigid material; and
at least one rattle disposed in the pocket and arranged to generate a rattling sound when the lure body is moved through water.

2. The lure of claim 1 wherein the at least one rattle comprises a pendulum suspended within the pocket.

3. The lure of claim 2 further comprising a hole formed longitudinally along the lure body and passing through the pocket.

4. The lure of claim 3 further comprising a wire shaft disposed in the hole, the wire shaft suspending the pendulum in the pocket.

5. The lure of claim 3 further comprising at least one weight disposed in the hole at a selected longitudinal position with reference to the lure body, the selected longitudinal position and a size of the weight selected such that the lure maintains a selected orientation in the water.

6. The lure of claim 5 further comprising a hook attachment coupled to a front of the head portion.

7. The lure of claim 6 further comprising at least one fishing hook attached to the hook attachment, a weight of the at least one fishing hook, the selected longitudinal position and a size of the at least one weight disposed in the hole and an angle with reference to a length of the hole of a tail coupled to the tail portion selected such that the lure maintains a selected orientation in the water.

8. The lure of claim 1 wherein the lure body comprises balsa wood.

9. The lure of claim 1 wherein the rigid material comprises rigid plastic.

10. The lure of claim 1 wherein the tail portion comprises a tail affixed thereto at an angle relative to the lure in order to obtain a selected dive angle and dive rate of the lure through the water.

11. The lure of claim 10 wherein the tail and the bill are configured to cause motion of the lure corresponding to motion of a live crayfish through water when the lure is moved in a direction toward the tail.

12. The lure of claim 1 wherein a size of the pocket is such that the lure body has a selected buoyancy.
